(19) United States
(12) Patent Application Publication
(10) Pub. No.: US 2007/0010284 A1
(43) Pub. Date: Jan. 11, 2007

(54) Mobile terminal for reducing generated impact

(75) Inventor: Sang-Yool Park, Seoul (KR)

Correspondence Address: JONATHAN Y. KANG, ESQ.;LEE, HONG, DEGERMAN, KANG & SCHMADEKA, P.C., 12th Floor, 801 S. Figueroa Street, Los Angeles, CA, 90017-5554, US

(73) Assignee: LG Electronics Inc.

(21) Appl. No.: 11/482,307

(22) Filed: Jul. 7, 2006

(30) Foreign Application Priority Data
Jul. 7, 2005 (KR) 10-2005-0061381

(51) Int. Cl. H04M 1/00

(52) U.S. Cl. 455/550.1

(57) ABSTRACT

The present invention relates to a mobile terminal capable of reducing an impact generated when a body of the mobile terminal is opened and closed. Preferably, the present invention comprises a first body and a second body slidably mounted to each other, an elastic force providing unit installed between the first body and the second body for providing an elastic force to aid movement between the first body and the second body when either of the first body and the second body is moved in an opened or closed direction with respect to the other, and a damping unit installed between the first body and the second body for reducing an impact generated when either of the first body and the second body is moved in the opened or closed direction with respect to the other.

### CROSS-REFERENCE TO RELATED APPLICATIONS

Pursuant to 35 U.S.C. §119(a), this application claims the benefit of earlier filing date and right of priority to Korean Application No. 10-2005-0061381, filed on Jul. 7, 2005, the contents of which are hereby incorporated by reference herein in their entirety.

### FIELD OF THE INVENTION

The present invention relates to a slide type mobile terminal and, more particularly, to a mobile terminal capable of reducing an impact generated when a body of the mobile terminal is opened and closed.

### BACKGROUND OF THE INVENTION

In general, mobile terminals may be categorized as either flip type mobile terminals or folder type mobile terminals. A flip type mobile terminal comprises a flip rotatably mounted on a main body to open and close an input button region. A folder type mobile terminal comprises a main body having dial buttons and menu buttons, and a folder rotatably mounted on the main body having a liquid crystal display (LCD) attached thereon.

Recently, demands have increased for mobile terminals having large screens for displaying various types of information as images. Accordingly, a slide type mobile terminal including a first body for allowing a user to input information and a second body having a large-size LCD for displaying various image information, wherein the second body is slidably opened and closed over the first body, is increasingly used.

FIG. 1 is a perspective view of a slide type mobile terminal in accordance with a related art. FIG. 2 is an exploded perspective view of the slide type mobile terminal in accordance with the related art. Referring to FIGS. 1 and 2, the related art slide type mobile terminal includes a first body 102, on which a display 110 for displaying various information is mounted and a second body 104, on which the first body 102 is slidably mounted. The second body 104 includes a key pad 106 mounted at its front surface for allowing a user to input information. Slide parts 120 and 122 are installed between the first body 102 and the second body 104, wherein the slide parts 120 and 122 allow the first body 102 to be slidably moved in a longitudinal direction of the second body 104.

The slide parts 120 and 122 include a slide groove 120 formed in a longitudinal direction at two sides of a rear surface of the first body 102, and a slide rail 122 protruded at two sides of a front surface of the second body 104. The slide rails 122 are inserted into the slide grooves 120 to be slidably movable therein.

A spring 130 is operationally installed between the first body 102 and the second body 104 such that when the first body 102 is pushed in an opened or closed direction with respect to the second body 104, the first body 102 is automatically opened or closed by an elastic force of the spring 130. Accordingly, a problem arises with the related art slide type mobile terminal. Specifically, when the first body 102 is opened or closed, because it is automatically opened or closed by the elastic force of the spring, an impact is generated causing damage to the mobile terminal. Moreover, a noise is generated due to the impact.

### SUMMARY OF THE INVENTION

The present invention is related to a mobile terminal capable of reducing an impact generated when a body of the mobile terminal is opened and closed.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a mobile terminal for reducing a generated impact, the mobile terminal comprising a first body and a second body slidably mounted to each other, an elastic force providing unit installed between the first body and the second body for providing an elastic force to aid movement between the first body and the second body when the first body and the second body are moved relative to each other, and a damping unit installed between the first body and the second body for reducing an impact generated when the first body and the second body are moved relative to each other.

In one aspect of the invention, the mobile terminal further comprises a locking unit installed between the first body and the second body for locking the first body to the second body when the first body and the second body are in a closed state with each other. Preferably, the locking unit comprises a button installed at the second body and capable of being pressed to be moved, a push rod connected to the button, wherein the push rod is linearly moved when the button is pressed, and a hooking rod fixed to the first body, wherein the hooking rod is movably installed in a longitudinal direction at the second body and capable of being engaged by the push rod. Preferably, a biasing member is installed at the push rod for returning the button to an original state.

In another aspect of the invention, the elastic force providing unit comprises an operation rod fixed at a rear surface of the first body and movably disposed at a guide groove formed at the second body in a longitudinal direction, and a biasing member installed between the guide groove and the operation rod for providing an elastic force to the operation rod.

Preferably, the damping unit comprises a rack gear formed in a longitudinal direction at one side of the operation rod, a pinion gear operationally coupled to the rack gear, and a damper fixed at the second body and connected to the pinion gear for slowing rotation of the pinion gear. Preferably, the damper comprises a housing fixed at a mounting part formed at the second body and having fluid therein, a rotational shaft rotatably disposed at the housing and operationally coupled to the pinion gear, and rotational blades disposed at an outer circumferential surface of the rotational shaft and having an orifice for generating flow resistance when the fluid passes therethrough. Preferably, the rotational blades are disposed at equal intervals at the outer circumferential surface of the rotational shaft.

In accordance with another embodiment of the present invention, a mobile terminal for reducing a generated impact comprises a first body and a second body slidably mounted to each other, and a slide module installed between the first body and the second body for slidably moving the first body and the second body relative to each other, wherein the slide module comprises a first slide member formed at the first body, a second slide member formed at the second body, wherein the first slide member and the second slide member are slidably mounted to each other, and a damping unit installed between the first slide member and the second slide member for performing a damping operation when the first slide member and the second slide member are moved relative to each other.

In one aspect of the present invention, the mobile terminal further comprises a guide bar mounted in a longitudinal direction at the first slide member, and a guide hole formed at the second slide member for allowing the guide bar to be inserted and linearly moved therein.

In another aspect of the present invention, the mobile terminal further comprises an elastic force providing unit installed between the first slide member and the second slide member for providing an elastic force to aid movement between the first slide member and the second slide member when the first slide member and the second slide member are moved relative to each other.

Preferably, the elastic force providing unit comprises an operation rod fixed at a rear surface of the first body and movably disposed at a guide groove formed at the second body in a longitudinal direction, and a biasing member installed between the guide groove and the operation rod for providing an elastic force to the operation rod.

In a further aspect of the present invention, the damping unit comprises a rack gear formed in a longitudinal direction at one side of the first body, a pinion gear operationally coupled to the rack gear, and a damper fixed at the second body and connected to the pinion gear for performing a damping operation when the pinion gear is rotated. Preferably, the damper comprises a housing fixed at a mounting part formed at the second body and having fluid therein, a rotational shaft rotatably disposed at the housing and operationally coupled to the pinion gear, and rotational blades disposed at an outer circumferential surface of the rotational shaft and having an orifice for generating flow resistance when the fluid passes therethrough.

In accordance with another embodiment of the present invention, an apparatus for reducing an impact in a slide-type mobile terminal comprises an elastic force providing unit installed between a first body and a second body of the slide-type mobile terminal, the elastic force providing unit for providing an elastic force to aid relative movement between the first body and the second body when the first body and the second body are moved relative to each other, and a damping unit installed between the first body and the second body for performing a damping operation when the first body and the second body are moved relative to each other.

In one aspect of the present invention, the elastic force providing unit comprises an operation rod fixed at a rear surface of the first body and movably disposed at a guide groove formed at the second body in a longitudinal direction, and a biasing member installed between the guide groove and the operation rod for providing an elastic force to the operation rod.

In another aspect of the present invention, the damping unit comprises a rack gear formed in a longitudinal direction at one side of the operation rod, a pinion gear operationally coupled to the rack gear, and a damper fixed at the second body and connected to the pinion gear for slowing rotation of the pinion gear.

Preferably, the damper comprises a housing fixed at a mounting part formed at the second body and having fluid therein, a rotational shaft rotatably disposed at the housing and operationally coupled to the pinion gear, and rotational blades disposed at an outer circumferential surface of the rotational shaft and having an orifice for generating flow resistance when the fluid passes therethrough. Preferably, the rotational blades are disposed at equal intervals at the outer circumferential surface of the rotational shaft.

Therefore, an object of the present invention is to provide a mobile terminal capable of reducing an impact generated when it is opened and closed by having a damping unit to perform a damping operation when it is opened and closed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a perspective view of a slide type mobile terminal in accordance with a related art.

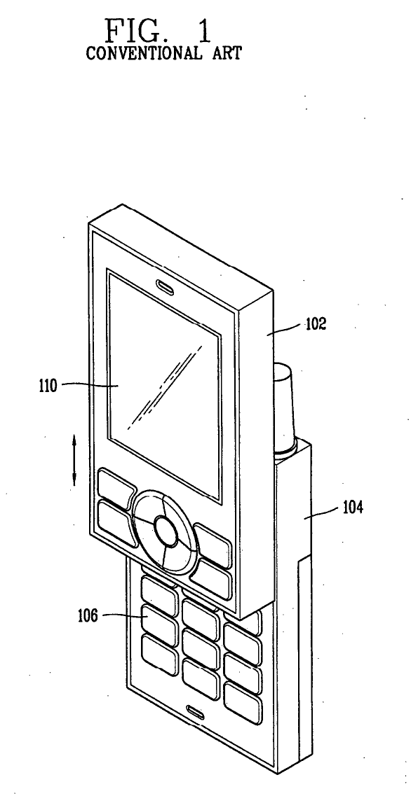

FIG. 2 is an exploded perspective view of the slide type mobile terminal in accordance with the related art.

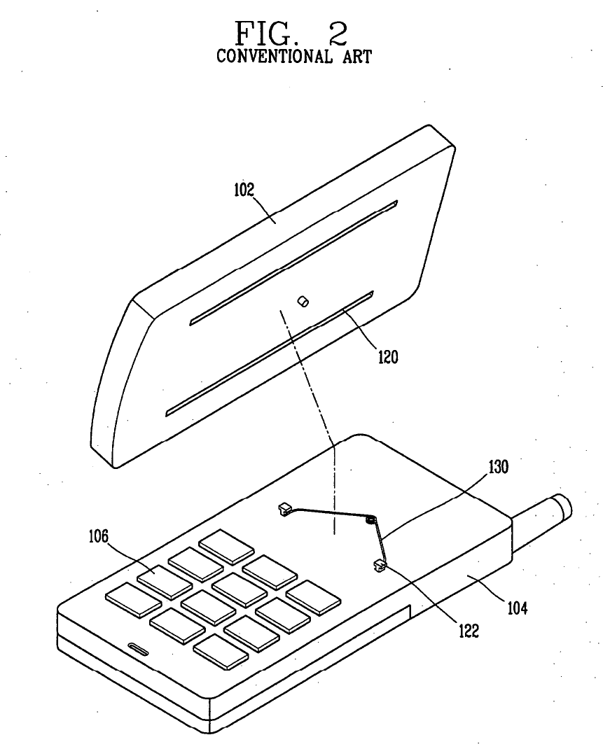

FIG. 3 is a perspective view of a mobile terminal in accordance with one embodiment of the present invention.

FIG. 4 is an exploded perspective view of the mobile terminal in accordance with one embodiment of the present invention.

FIG. 5 is a front view of the mobile terminal in accordance with one embodiment of the present invention.

FIG. 6 is a sectional view of a damper in accordance with one embodiment of the present invention.

FIG. 7 is a view showing an operation state of the mobile terminal in accordance with one embodiment of the present invention.

FIG. 8 is a perspective view of a slide module in accordance with another embodiment the present invention.

### DETAILED DESCRIPTION OF THE PREFERRED EMBODIMENTS

The present invention is related to a mobile terminal capable of reducing an impact generated when a body of the mobile terminal is opened and closed.

A mobile terminal in accordance with the present invention will now be described with reference to the accompanying drawings. There can be a plurality of embodiments of the present invention, of which a preferred one will be described.

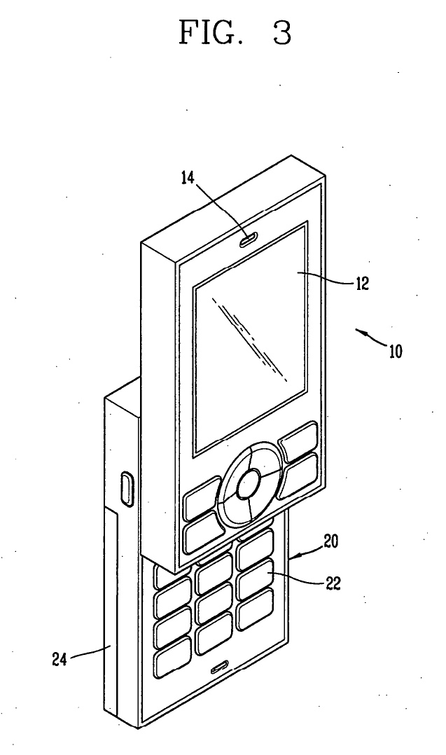

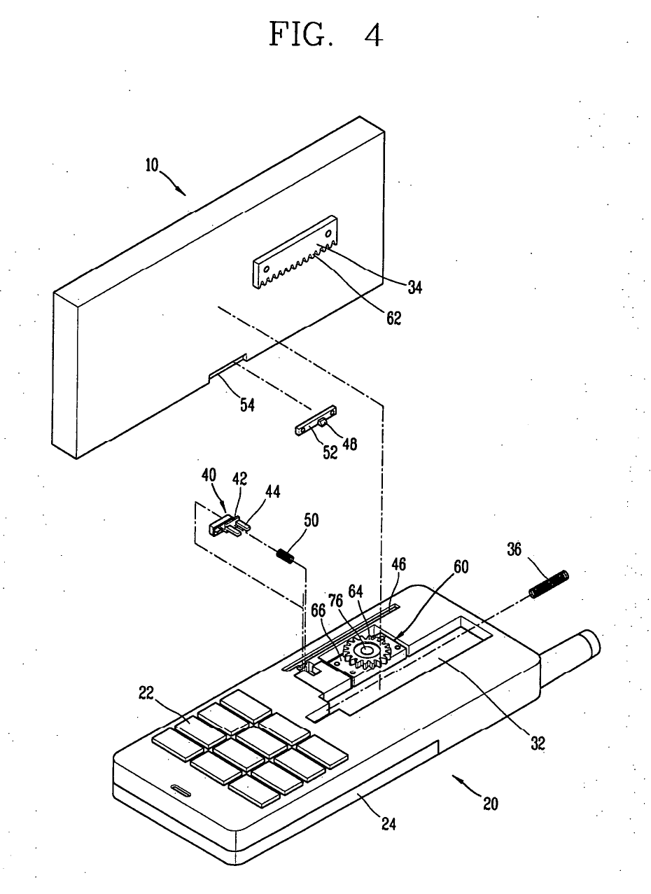

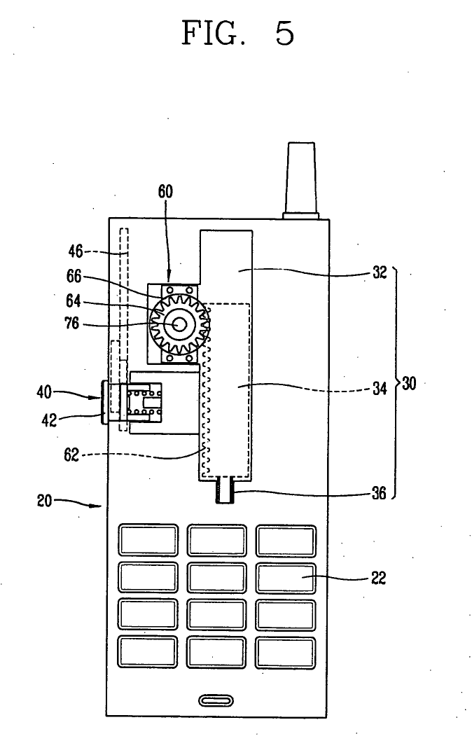

FIG. 3 is a perspective view of a mobile terminal in accordance with one embodiment of the present invention. FIG. 4 is an exploded perspective view of the mobile terminal in accordance with one embodiment of the present invention. FIG. 5 is a front view of the mobile terminal in accordance with one embodiment of the present invention.

Referring to FIG. 3, the mobile terminal in accordance with the present invention includes a first body 10 having a display 12 for displaying various information and a speaker 14 for outputting a sound. A second body 20 is slidably mounted on the first body 10 and has a key pad 22 mounted on its front surface for inputting information by a user. A battery 24 is mounted on a rear surface of the second body 20. Referring to FIGS. 4, 5 and 7, an elastic force providing unit 30 is installed between the first body 10 and the second body 20 and provides an elastic force in a direction that the first body 10 is opened. A locking unit 40 is installed between the first body 10 and the second body 20 for locking the first body 10 when the first body 10 is in a closed state. The mobile terminal further includes a damping unit 60 for performing a damping operation to reduce a generated impact when the first body 10 is slidably moved.

The elastic force providing unit 30 includes a guide groove 32 formed in a longitudinal direction on the front surface of the second body 20, a moving rod 34 fixed at the rear surface of the first body 10 and moved along the guide groove 32, and a biasing member (elastic member) 36 installed between the moving rod 34 and the guide groove 32 for providing an elastic force to the moving rod 34.

When the locking unit 40 is unlocked, the moving rod 34 of the elastic force providing unit 30 is slidably moved along the guide groove 32 by the elastic force of the elastic member 36. Accordingly, the moving rod 34 is moved in a direction that the fixed first body 10 is opened.

The locking unit 40 includes a button 42 disposed to be exposed at the side of the second body 20 and operated when pressed. A push rod 44 connected with the button 42 is linearly moved when the button 42 is pressed. A hooking rod 48 is fixed on the first body 10 and is moved along a guide slot 46 formed on the upper surface of the second body 20. Preferably, the hooking rod 48 is hooked by the push rod 44. A return spring 50 is mounted at the push rod 44 and facilitates returning the button 42 to its original state.

The hooking rod 48 is protruded in a vertical direction at a lower surface of a fixing bracket 52 engaged with a fixing recess 54 formed at the first body 10. One side of the hooking rod 48 is formed at a right angle so as to be caught by the push rod 44. The other side of the hooking rod 48 has a sloped surface such that it may not be caught when the first body 10 is moved in the closing direction.

As for the locking unit 40, when the button 42 is pressed, the push rod 44 is linearly moved to be released from the hooking rod 48, so as to be unlocked. Then, the first body 10 is slidably moved in a direction such that it is automatically opened by the elastic force of the spring 36.

The damping unit 60 includes a rack gear 62 formed in a longitudinal direction at one side of the moving rod 34, a pinion gear 64 operationally coupled to the rack gear 62 and rotated when the moving rod 34 is linearly moved, and a damper 66 mounted at the pinion gear 64 and fixed at the second body 20 to damp in order to slowly rotate the pinion gear 64.

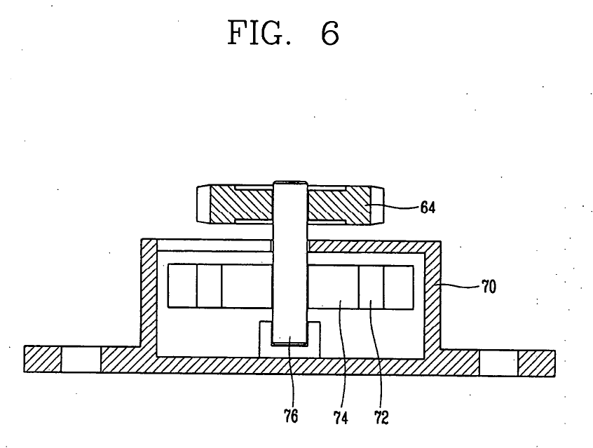

With reference to FIG. 6, the damper 66 includes a damper housing 70 fixed at the second body 20 and filled with a fluid therein. A plurality of rotation blades 74 are rotatably mounted inside the damper housing 70 and include orifices 72 for generating flow resistance while the fluid passes therethrough. The damper 66 further includes a rotational shaft 76 at which the rotation blades 74 and the pinion gear 64 are fixed.

In the damping unit 60, when the pinion gear 64 operationally coupled to the rack gear 62 is rotated, the rotational shaft 76 and the rotation blades 74 are rotated. Accordingly, fluid passes through the orifices 72 formed at the rotation blades 74, thus producing a flow resistance to generate a damping force.

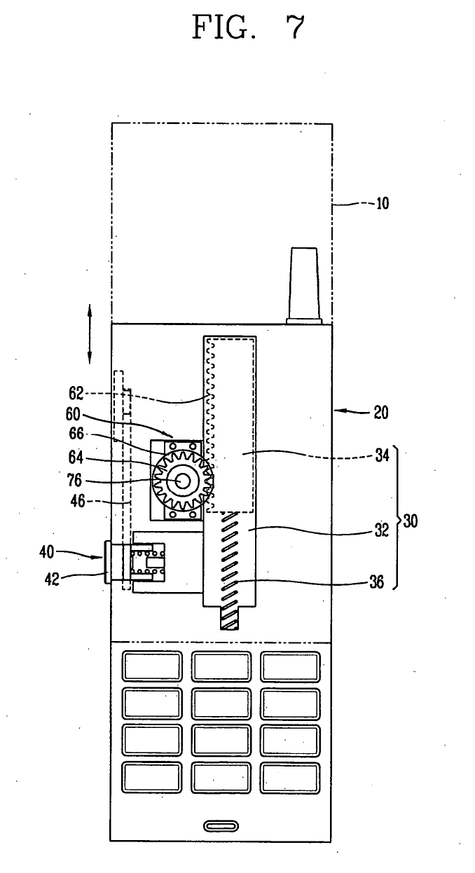

The operation of the mobile terminal constructed as described above will now be explained as follows. FIG. 7 is a view showing an operation state of the mobile terminal in accordance with one embodiment of the present invention.

When the first body 10 is in a closed state, the hooking rod 48 of the locking unit 40 is caught by the push rod 44, maintaining the terminal in the closed state. At this time, the biasing member 36 disposed at the second body 20 is in a compressed state.

While in the closed state, when the user presses the button 42 to use the terminal, the push rod 44 is linearly moved to be released from the hooking rod 48 to unlock the first body 10. Then, the moving rod 34 is linearly moved along the guide groove 32 according to the elastic force of the elastic member 36, and accordingly, the moving rod 34 is slidably moved in a direction that the first body 10 is opened.

At this time, the pinion gear 64 operationally coupled to the rack gear 62 formed at the moving rod 34 is rotated. Preferably, the pinion gear 64 is slowly rotated according to the damping operation of the damping unit 60 mounted at the pinion gear 64. Accordingly, the moving rod 34 is slowly moved to reduce an impact generated when the first body 10 is opened.

Referring to the operation of the damping unit 60, when the pinion gear 64 is rotated, the rotational shaft 76 at which the pinion gear 64 is fixed is rotated. The rotation blades 74 are then rotated according to the rotation of the rotational shaft 76. When the fluid filled in the housing 70 passes through the orifices 72 formed at the rotation blades 74, flow resistance is generated making the pinion gear 64 rotate slowly.

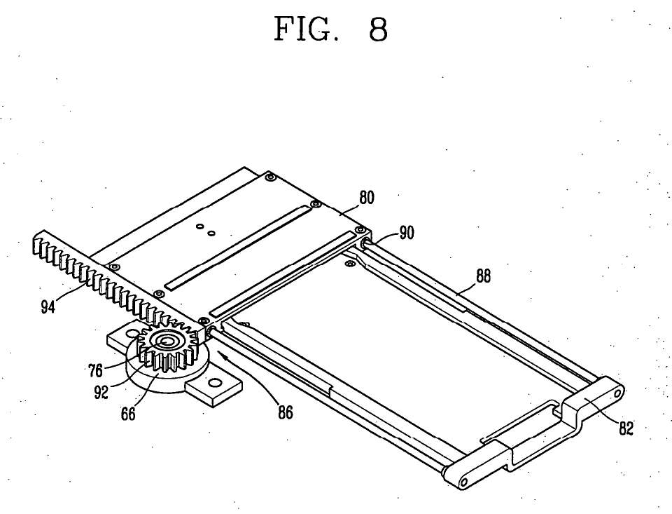

FIG. 8 is a perspective view of a slide module in accordance with one embodiment of the present invention. A slide module in accordance with the present invention includes a first slide member 80 fixed at the first body 10 and a second slide member 82 fixed at the second body 20. Preferably, the first slide member 80 is slidably mounted with respect to the second slide member 82. An elastic force providing unit (not shown) is installed between the first slide member 80 and the second slide member 88 and provides an elastic force when the first slide member 80 is slidably moved in an opened or closed direction. A damping unit 86 is installed between the first and second slide members 80 and 82 for absorbing an impact generated when the first slide member 80 is slidably moved in the opened or closed direction.

A guide bar 88 is mounted in a longitudinal direction at both sides of the second slide member 82. Guide holes 90 are formed at both side surfaces of the first slide member 80. Preferably, the guide bars 88 are inserted in the guide holes 90, wherein the guide holes 90 may be linearly moved around and along the guide bars 88.

One side of the elastic force providing unit is fixed at the first slide member 80 and the other side thereof is fixed at the second slide member 82. The elastic force providing unit pushes the first slide member 80 in the opened or closed direction. Preferably, when the first slide member 80 passes a dead point, the elastic force providing unit provides elastic force to the first slide member 80. Any structure can be applicable thereto.

The damping unit 86 includes a rotational unit installed between the first and second slide members 80 and 82 and rotated when the first slide member 80 is slidably moved. A damper 66 is installed at the rotational unit and generates a damping force when the rotational unit is rotated.

The rotational unit includes a rack gear 94 fixed at the first slide member 80, wherein and the rack gear 94 linearly moves together with the first slide member 80. A pinion gear 92 is operationally coupled to the rack gear 84. The damper 66 is installed at the pinion gear 92.

Preferably, the damper 66 is fixed at the second slide member 82 and the pinion gear 92 is rotatably mounted at the damper 66. Preferably, the damper 66 generates a damping force when the pinion gear 92 is rotated. Preferably, the damper 66 has the same structure as the damper 66 described in FIGS. 4-7 above.

In the mobile terminal in accordance with the present invention, when the first slide member 80 fixed at the first body 10 is slidably moved in the opened or closed direction, the elastic force providing unit provides elastic force to the first slide member 80 so that the first slide member 80 is slidably moved automatically. Preferably, the first slide member 80 is slowly moved according to the damping operation of the damping unit 86. Thus, an impact generated when the slide member 80 is slidably moved is reduced.

In more detail, when the first slide member 80 is slidably moved, the rack gear 94 mounted at the first slide member 80 is linearly moved. Furthermore, the pinion gear 92 operationally coupled to the rack gear 94 is also rotated. Accordingly, the damper 66, wherein the pinion gear 92 is mounted, damps the rotational force of the pinion gear 92. Therefore, the first slide member 80 can be moved slowly.

As so far described, the mobile terminal in accordance with the present invention is advantageous because the damping unit is installed between the first and second bodies to perform the damping operation when the first body is slidably moved, thereby enabling the first body to be slowly opened to reduce an impact.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile terminal for reducing a generated impact, the mobile terminal comprising:
a first body and a second body slidably mounted to each other;
an elastic force providing unit installed between the first body and the second body for providing an elastic force to aid movement between the first body and the second body when the first body and the second body are moved relative to each other; and
a damping unit installed between the first body and the second body for reducing an impact generated when the first body and the second body are moved relative to each other.

2. The mobile terminal of claim 1, further comprising a locking unit installed between the first body and the second body for locking the first body to the second body when the first body and the second body are in a closed state with each other.

3. The mobile terminal of claim 2, wherein the locking unit comprises:
a button installed at the second body and capable of being pressed to be moved;
a push rod connected to the button, wherein the push rod is linearly moved when the button is pressed; and
a hooking rod fixed to the first body, wherein the hooking rod is movably installed in a longitudinal direction at the second body and capable of being engaged by the push rod.

4. The mobile terminal of claim 3, wherein a biasing member is installed at the push rod for returning the button to an original state.

5. The mobile terminal of claim 1, wherein the elastic force providing unit comprises:
an operation rod fixed at a rear surface of the first body and movably disposed at a guide groove formed at the second body in a longitudinal direction; and
a biasing member installed between the guide groove and the operation rod for providing an elastic force to the operation rod.

6. The mobile terminal of claim 5, wherein the damping unit comprises:
a rack gear formed in a longitudinal direction at one side of the operation rod;
a pinion gear operationally coupled to the rack gear; and
a damper fixed at the second body and connected to the pinion gear for slowing rotation of the pinion gear.

7. The mobile terminal of claim 6, wherein the damper comprises:
a housing fixed at a mounting part formed at the second body and having fluid therein;
a rotational shaft rotatably disposed at the housing and operationally coupled to the pinion gear; and
rotational blades disposed at an outer circumferential surface of the rotational shaft and having an orifice for generating flow resistance when the fluid passes therethrough.

8. The mobile terminal of claim 7, wherein the rotational blades are disposed at equal intervals at the outer circumferential surface of the rotational shaft.

9. A mobile terminal for reducing a generated impact, the mobile terminal comprising:
a first body and a second body slidably mounted to each other; and
a slide module installed between the first body and the second body for slidably moving the first body and the second body relative to each other, wherein the slide module comprises:
a first slide member formed at the first body;
a second slide member formed at the second body, wherein the first slide member and the second slide member are slidably mounted to each other; and
a damping unit installed between the first slide member and the second slide member for performing a damping operation when the first slide member and the second slide member are moved relative to each other.

10. The mobile terminal of claim 9, further comprising:
a guide bar mounted in a longitudinal direction at the first slide member; and
a guide hole formed at the second slide member for allowing the guide bar to be inserted and linearly moved therein.

11. The mobile terminal of claim 9, further comprising an elastic force providing unit installed between the first slide member and the second slide member for providing an elastic force to aid movement between the first slide member and the second slide member when the first slide member and the second slide member are moved relative to each other.

12. The mobile terminal of claim 11, wherein the elastic force providing unit comprises:
an operation rod fixed at a rear surface of the first body and movably disposed at a guide groove formed at the second body in a longitudinal direction; and
a biasing member installed between the guide groove and the operation rod for providing an elastic force to the operation rod.

13. The mobile terminal of claim 9, wherein the damping unit comprises:
a rack gear formed in a longitudinal direction at one side of the first body;
a pinion gear operationally coupled to the rack gear; and
a damper fixed at the second body and connected to the pinion gear for performing a damping operation when the pinion gear is rotated.

14. The mobile terminal of claim 13, wherein the damper comprises:
a housing fixed at a mounting part formed at the second body and having fluid therein;
a rotational shaft rotatably disposed at the housing and operationally coupled to the pinion gear; and
rotational blades disposed at an outer circumferential surface of the rotational shaft and having an orifice for generating flow resistance when the fluid passes therethrough.

15. An apparatus for reducing an impact in a slide-type mobile terminal, the apparatus comprising:
an elastic force providing unit installed between a first body and a second body of the slide-type mobile terminal, the elastic force providing unit for providing an elastic force to aid relative movement between the first body and the second body when the first body and the second body are moved relative to each other; and
a damping unit installed between the first body and the second body for performing a damping operation when the first body and the second body are moved relative to each other.

16. The apparatus of claim 15, wherein the elastic force providing unit comprises:
an operation rod fixed at a rear surface of the first body and movably disposed at a guide groove formed at the second body in a longitudinal direction; and
a biasing member installed between the guide groove and the operation rod for providing an elastic force to the operation rod.

17. The apparatus of claim 16, wherein the damping unit comprises:
a rack gear formed in a longitudinal direction at one side of the operation rod;
a pinion gear operationally coupled to the rack gear; and
a damper fixed at the second body and connected to the pinion gear for slowing rotation of the pinion gear.

18. The mobile terminal of claim 17, wherein the damper comprises:
a housing fixed at a mounting part formed at the second body and having fluid therein;
a rotational shaft rotatably disposed at the housing and operationally coupled to the pinion gear; and
rotational blades disposed at an outer circumferential surface of the rotational shaft and having an orifice for generating flow resistance when the fluid passes therethrough.

19. The mobile terminal of claim 18, wherein the rotational blades are disposed at equal intervals at the outer circumferential surface of the rotational shaft.
